(19) United States
(12) Patent Application Publication
(10) Pub. No.: US 2025/0272452 A1
(43) Pub. Date: Aug. 28, 2025

(54) SYSTEMS AND METHODS FOR OPTIMIZATION OF GREENHOUSE GAS REDUCTION

(71) Applicant: Kinaxis Inc., Ottawa (CA)

(72) Inventor: Yassine Lahlou-Kamal, Toronto (CA)

(73) Assignee: Kinaxis Inc., Ottawa (CA)

(21) Appl. No.: 19/066,893

(22) Filed: Feb. 28, 2025

Related U.S. Application Data
(60) Provisional application No. 63/558,828, filed on Feb. 28, 2024.

(51) Int. Cl. G06F 30/20; G06F 111/06

(52) U.S. Cl. CPC G06F 30/20; G06F 2111/06

(57) ABSTRACT

Systems and methods for reducing computer resources in determining a set of solutions for multi-objective optimization based on competing metrics. The methods and system include: receiving data related to each metric; optimizing each metric, irrespective of the other metric to provide endpoints of a Pareto front. A third optimization is made between the end points, thereby providing three optimization points to generate a Pareto front which represents a set of solutions for the competing metrics.

The present application claims the benefit of U.S. Provisional Patent Application No. 63/558,828 filed Feb. 28, 2024, which is expressly incorporated by reference in its entirety herein.

### BACKGROUND

Multi-objective optimization involves minimizing or maximizing multiple objective functions. It has application in many fields, such as manufacturing and engineering, where it is important to understand what the tradeoffs are when making design decisions. Examples include structural design, shape optimization, topology optimization (including airfoils) and electromagnetic optimization. In such optimizations, there are usually competing metrics.

For example, multi-objective optimization can be used in the designing of a welded beam, where the structural design problem is to determine dimensions of a beam and the weld, where there is a trade-off between the beam strength and costs. A multi-objective optimization provides a user with a set of solutions (i.e. beam and weld dimensions) varying from minimal cost to minimal strength.

There are many computational techniques used in the field of multi-objective optimization. In one approach, an objective function can be used to optimize a first metric. If a second competing metric is introduced into the picture, there is a trial-and-error, lengthy iterative procedure which results in a set of solutions provided to a user, enabling them to see trade-offs between the metrics, which allows the user to choose an optimal design.

One traditional technique used to provide a set of solutions, includes changing the second metric in small increments. At each incremental value, the second metric is introduced as a constraint to the objective function, which is then used to optimize the first metric. This intensive computation procedure is performed at each incremental value of the second metric, resulting in a set of solutions that illustrate the trade-off between the two metrics. This approach requires intensive computer resources to perform the optimization over hundreds, if not thousands of times, through each incremental point of the second metric.

Another traditional technique used to provide a set of solutions, is to use the objective function to optimize the first metric, irrespective of the second competing metric, followed by using a separate heuristic or a second objective function to optimize the second metric, irrespective of the first metric. This approach suffers from two issues. First, is the degradation of optimization performance, in that a Pareto equilibrium is not achieved between the two competing metrics. Second, using two different methods and reconciling the results from both approaches significantly extends the computation time and resources required for the entire process.

### BRIEF SUMMARY

Methods and systems disclosed herein provide a set of solutions that optimize both metrics in a manner that reduces the amount of computer resources used in traditional heuristically approaches described above. Furthermore, methods and systems disclosed herein recommend multiple pareto-efficient solutions, using reduced computer processing time.

That is, the methods and systems disclosed herein, reduce the solution space significantly, thus reducing the computing resources needed. In some embodiments, the methods and systems disclosed herein allow for the optimization of several metrics, simultaneously, in one loop, thereby reducing the both the computational resources and time used in traditional methods. It should be noted that the methods and systems disclosed herein are not automation of a trial and error process described above. The methods and systems disclosed herein, nonetheless, vastly reduce the use of computational resources and time.

In one aspect, a computing apparatus is provided, that includes a processor. The computing apparatus also includes a memory storing instructions that, when executed by the processor, configure the apparatus to: receive, by the processor, a first set of data related to a first metric and a second set of data related to a second metric; optimize, by the processor, a first objective function with respect to the first metric, irrespective of the second metric, resulting in a minimum limit of the first metric; determine, by the processor, a maximum limit of the second metric from the minimum limit of the first metric, thereby defining a first end point; optimize, by the processor, a second objective function with respect to the second metric, irrespective of the first metric, resulting in a minimum limit of the second metric; determine, by the processor, a maximum limit of the first metric from the minimum limit of the second metric, thereby defining a second end point; select, by the processor, a point between the first end point and the second end point, the point consisting of a value of the first metric and a value of the second metric; reconcile, by the processor, the first metric and the second metric at the point in between the first end point and the second end point; and generate, by the processor, a Pareto Front between the first end point and the second end point.

When reconciling the first metric and the second metric, the apparatus can be further configured to optimize, by the processor, one of the metrics at the point, subject to constraining the other metric. The metric that optimizes fastest at its respective end point, can be selected for optimization at the point between the first end point and the second end point. Furthermore, the Pareto Front can be generated based on a power law.

When reconciling the first metric and the second metric, the apparatus can be further configured to optimize, by the processor, one of the metrics at the point, subject to constraining the other metric, resulting in a reconciled midpoint; and when generating the Pareto Front, the apparatus can be further configured to generate, by the processor, a power law based on the first end point, the second end point, and the reconciled midpoint. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: receive, by the processor, a first set of data related to a first metric and a second set of data related to a second metric; optimize, by the processor, a first objective function with respect to the first metric, irrespective of the second metric, resulting in a minimum limit of the first metric; determine, by the processor, a maximum limit of the second metric from the minimum limit of the first metric, thereby defining a first end point; optimize, by the processor, a second objective function with respect to the second metric, irrespective of the first metric, resulting in a minimum limit of the second metric; determine, by the processor, a maximum limit of the first metric from the minimum limit of the second metric, thereby defining a second end point; select, by the processor, a point between the first end point and the second end point, the point consisting of a value of the first metric and a value of the second metric; reconcile, by the processor, the first metric and the second metric at the point in between the first end point and the second end point; and generate, by the processor, a Pareto Front between the first end point and the second end point.

When reconciling the first metric and the second metric, the computer can be further configured to optimize, by the processor, one of the metrics at the point, subject to constraining the other metric. The metric that optimizes fastest at its respective end point, can be selected for optimization at the point between the first end point and the second end point. Furthermore, the Pareto Front can be generated based on a power law.

When reconciling the first metric and the second metric, the computer can be further configured to optimize, by the processor, one of the metrics at the point, subject to constraining the other metric, resulting in a reconciled midpoint; and when generating the Pareto Front, the computer can be further configured to generate, by the processor, a power law based on the first end point, the second end point, and the reconciled midpoint. Other technical features may be readily apparent to one skilled in the art from the following figures, descriptions, and claims.

In one aspect, a computer-implemented method for reducing computer resources in determining an optimization based on a first metric and a second metric, the method includes: receiving, by a processor, a first set of data related to the first metric and a second set of data related to the second metric; optimizing, by the processor, a first objective function with respect to the first metric, irrespective of the second metric, resulting in a minimum limit of the first metric; determining, by the processor, a maximum limit of the second metric from the minimum limit of the first metric, thereby defining a first end point; optimizing, by the processor, a second objective function with respect to the second metric, irrespective of the first metric, resulting in a minimum limit of the second metric; determining, by the processor, a maximum limit of the first metric from the minimum limit of the second metric, thereby defining a second end point; selecting, by the processor, a point between the first end point and the second end point, the point consisting of a value of the first metric and a value of the second metric; reconciling, by the processor, the first metric and the second metric at the point in between the first end point and the second end point; and generating, by the processor, a Pareto Front between the first end point and the second end point.

When reconciling the first metric and the second metric, the computer-implemented method may also include optimizing, by the processor, one of the metrics at the point, subject to constraining the other metric. The metric that optimizes fastest at its respective end point, can be selected for optimization at the point between the first end point and the second end point. Furthermore, the Pareto Front can be generated based on a power law.

When reconciling the first metric and the second metric, the computer-implemented invention can also include optimizing, by the processor, one of the metrics at the point, subject to constraining the other metric; and when generating the Pareto Front, the computer-implemented invention can also include generating, by the processor, a power law based on the first end point, the second end point, and the reconciled midpoint. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for Optimization of Greenhouse Gas Reduction in accordance with one embodiment.

FIG. 2A illustrates a solution space for competing two metrics.

FIG. 2B illustrates a solution space for competing two metrics.

FIG. 3 illustrates a block diagram in accordance with one embodiment.

FIG. 4 illustrates generation of a pareto-efficient solution space in accordance with one embodiment.

FIG. 5 illustrates a block diagram in accordance with one embodiment.

FIG. 6 illustrates application of a set of pareto-efficient solutions in accordance with one embodiment.

FIG. 7 illustrates application of a set of pareto-efficient solutions in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, include one or more physical or logical blocks of computer instructions which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operation al steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

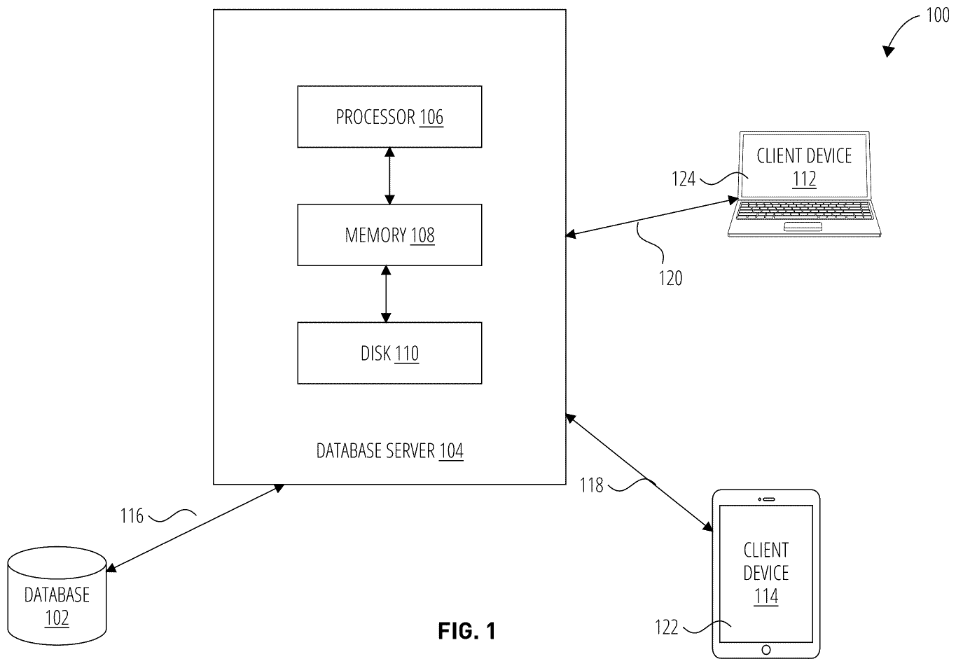

FIG. 1 illustrates an example of a system 100 for [INSERT TITLE]

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also include a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

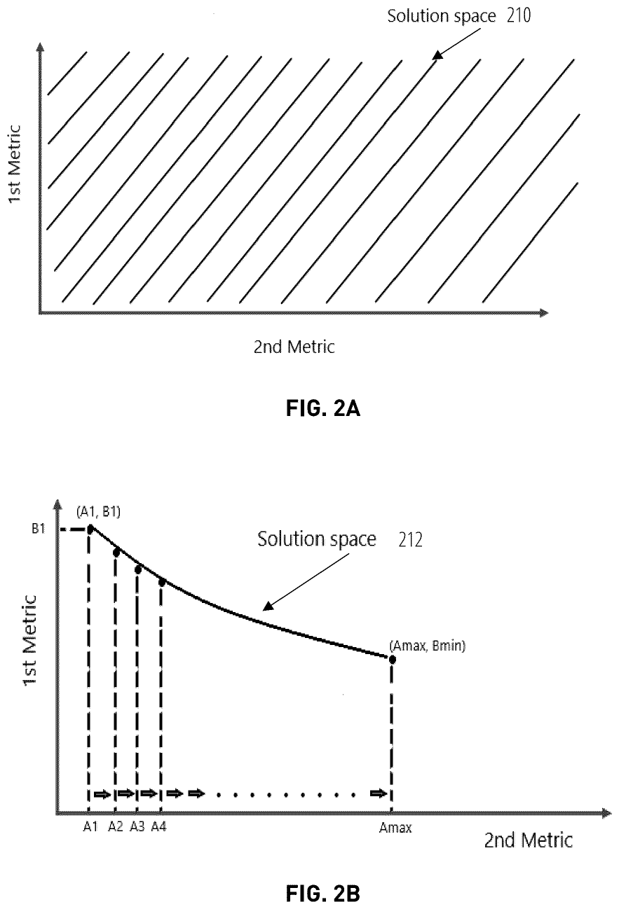

FIG. 2A illustrates a solution space 210 for balancing two competing metrics. There are theoretically an infinite number of ways of balancing the two metrics, as shown by the shaded lines, which defines the solutions space. There are traditional techniques to reducing the solution space, one set of which is illustrated in FIG. 2B.

FIG. 2B illustrates a solution space 212 for balancing two competing metrics, using a traditional trial-and-error, iterative approach to reduce the solution space 210 shown in FIG. 2A.

In this approach, a first metric can be optimized using an objective function. In FIG. 2B, the 1st metric has a maximum (or optimal) value of B1. The second metric is calculated based on the results from optimizing the first metric, and is shown as A1. The second metric is then changed incrementally from A1 to A2; the objective function is adjusted to include the changed second metric as a constraint, and the first metric is then optimized under this constraint. The first metric, now has an optimal value of B2, subject to the constraint of A2. This step is performed iteratively (A2 to A3 to A4 until Amax), until the solution space 212 is obtained. Solution space 212 is a reduction from solution space 210 shown in FIG. 2A. This iterative, trial-and-error method requires much computational resources and time.

For example, in relation to designing a welded beam, the first metric can be beam strength, and can include information related load capacity, maximal angle of deflection, and so on. The second metric can be cost savings, and can include information related to a volume of the weld material, a volume of the beam, and cost per unit volume of each material. With reference to FIG. 2B, one metric can be the beam strength (the Y-axis), while the second metric can be cost savings (the X-axis).

Using the trial-and-error, iterative approach shown in FIG. 2A, the beam strength can be maximized using an objective function, and the ensuing cost saving is calculated; the objective function is adjusted to include an increased cost saving, and the ensuing beam strength is maximized. This is performed iteratively, until the solution space is reduced from solution space 210 to solution space 212. This method requires much computational resources and time.

With reference to FIG. 2B, one metric is the total cost of ordering, transporting and holding entities (the Y-axis), while the second metric is the total emission of CO2 gas (the X-axis).

Traditionally, there is a trial-and-error, iterative approach where costs can be minimized using an objective function, and the ensuing CO2 emission is calculated; the objective function is adjusted to include a reduced CO2 emission, and the ensuing costs are minimized. This is performed iteratively, until the solution space is reduced. This method requires much computational resources and time.

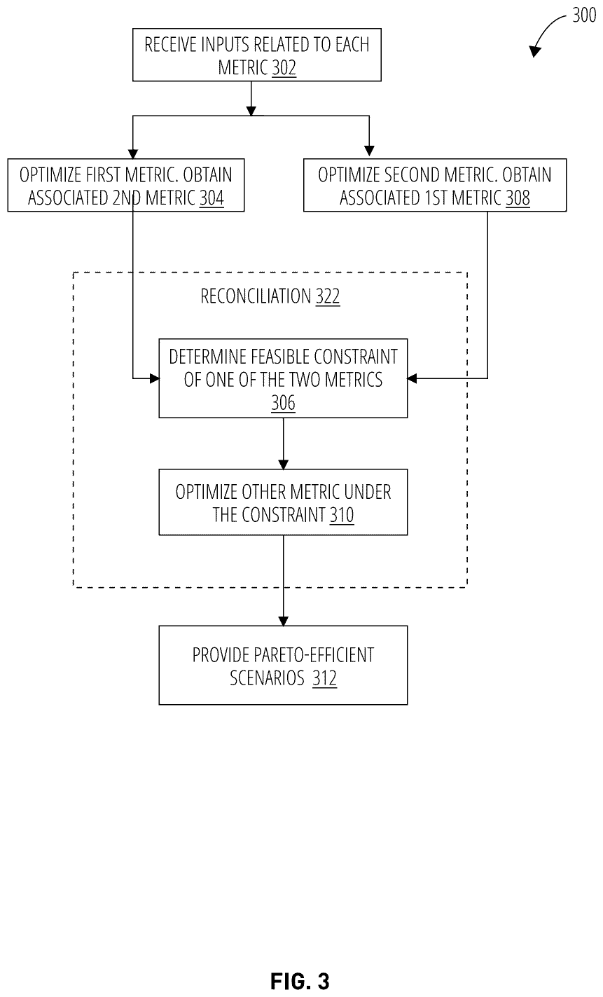

FIG. 3 illustrates a block diagram 300 in accordance with one embodiment of efficiently providing a set of solutions.

A processor may execute the following steps: at block 302, the processor can receive inputs related to each of the two competing metrics. For example, in relation to designing a welded beam, the first metric can be beam strength, and can include information related load capacity, maximal angle of deflection, and so on. The second metric can be cost savings, and can include information related to a volume of the weld material, a volume of the beam, and cost per unit volume of each material.

Next at block 304. the processor can optimize the first metric, using a first objective function, and optimize the second metric using a second objective function at block 308.

With reference to the welded beam example, at block 304, the beam strength is maximized using a first objective function. This provides a first set of beam dimensions, or, in other words, a first scenario. The associated beam cost saving is determined from this first scenario, which is a minimum possible value of the beam cost saving. At block 308, the beam cost saving is minimized using a second objective function. This provides a second set of beam dimensions, or, in other words, a second scenario. The associated beam strength is determined from this second scenario, which is the minimum possible value of the beam strength.

Next, at block 322, the processor performs reconciliation between the two objectives. This can be performed in two steps. At block 306, the processor can first determine a feasible constraint of one of the two metrics. At block 310, the processor then minimizes the other metric under this constraint, thereby reconciling the two metrics. The choice of which of the two metrics to optimize can be arbitrary. However, in some embodiments, the metric which is optimized faster (based on block 304 and block 308), can be the metric which is optimized, while constraining the other metric. The combination steps at block 306 and block 310 provides a reconciliation of the two objective functions. With reference to the welded beam example, a beam cost saving constraint can be determined from the minimum and maximum value of the beam cost saving. This constraint is then used to maximize the beam strength, thus providing a third scenario.

At block 312, a pareto front can be generated based on the three optimizations (at block 304, block 308 and block 310), thereby providing pareto-efficient scenarios (or solutions) at various levels of the two competing metrics.

In an example, the pareto front can be generated from the three optimization points. Two of the three are endpoints, corresponding to optimizing each metric separately. The third point is generated within this range by optimizing one metric while imposing a constraint based on the other metric; this constraint can be set at any point between the two end points. In an embodiment, the constraint can be set at the midpoint of the endpoints of the metric in question. Once the three points are established, a pareto front can be generated in the form: e(x)=a*x^{b}+c, where x represents one metric, and e(x) represents the other metric. A power law relationship can be used to capture of the curvature of the trade-off between the competing metrics.

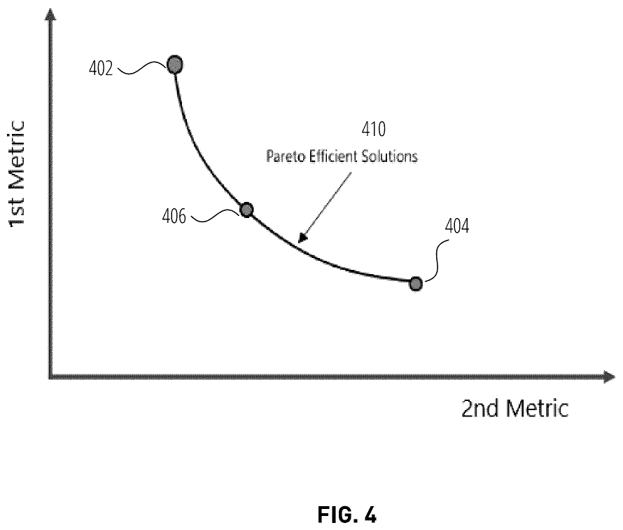

With reference to the welded beam example, a pareto front is generated, providing a continuous set of solutions of beam strength and beam cost saving, in a fraction of the time that has been traditionally required. This is because the optimization of each metric is performed only three times (rather than hundreds, if not thousands, of times using iteration), using their respective objective functions. leading to a reduction in computer processing time. In addition, the two objective functions are reconciled, with the generation of pareto-efficient solutions, thereby avoiding degradation in performance. A pareto-efficient set of solutions, generated by block diagram 300 is shown in FIG. 4.

FIG. 4 illustrates generation of a pareto-efficient solution space in accordance with one embodiment. Here, only three optimizations are performed, in order to generate pareto-efficient solutions 410: at 402, at 404 and at 406.

The optimal value of the first metric is obtained using block 304 of FIG. 3, and the associated second metric is obtained using the scenario from this first optimization, thus providing point 402. The optimal value of the second metric is obtained using block 308 of FIG. 3, and the associated first metric is obtained using the scenario from this second optimization, thus providing point 404.

The end points 402 and 404 are then used as the end points to generate a set of pareto-efficient solutions 410 between the two, by performing a third optimization and reconciliation in accordance with block 306 and block 310 of FIG. 3, thereby resulting in point 406. The optimal solutions are reduced to being found along a continuous line that is the set of pareto-efficient solutions 410, using processing time that is much faster and less intensive of computer resources than traditional methods.

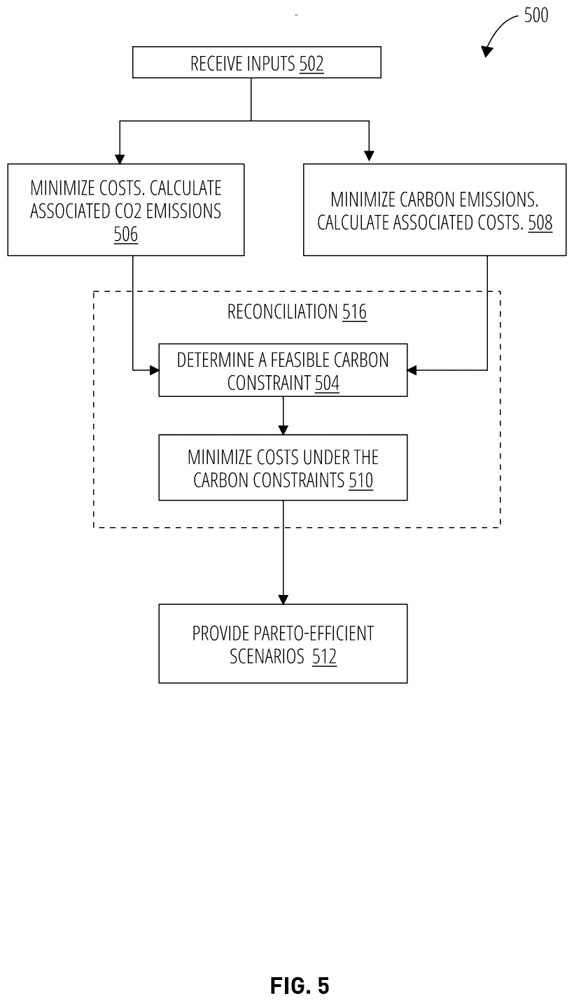

FIG. 5 illustrates a block diagram 500 in accordance with one embodiment. In this example, block diagram 500 is used to efficiently provide a solution space showing the tradeoff between costs and CO2 emissions when allocating inventory.

Currently, there are a number of conventional approaches that provide a solution space; each of which suffers from the following technical problems.

### Multi-Echelon Inventory Optimization (MEIO) and a Second Heuristic

A Multi-Echelon Inventory Optimization (MEIO) is a technique used to balance capital investment objectives and service-level goals in a supply chain for a wide range of stock-keeping units (SKUs) located in multiple locations. MEIO minimizes the holding costs of a company's inventory system but it does not concurrently optimize carbon emissions.

Currently, achieving optimization of carbon emissions requires introducing separate heuristics to approximate potential carbon emission reduction opportunities after the MEIO process is completed and leads to the two major downsides previously discussed: degradation of performance by pursuing both cost and greenhouse gas emission reductions separately (which does not lead to a Pareto-equilibrium between the two factors); and extensive processing time that results from running two different methods and reconciling the results from both approaches.

2) Iterative Approach with Constraints

### Example 1: Carbon Emissions as Optimization Constraints

In an example, a company attempting to reduce emissions faces computational challenges when manually setting carbon emission constraints in optimization models. They must iteratively run the model with varying emission reduction targets (e.g., −5%, −10%, −15%, −20%), a process that becomes computationally intensive, especially if the desired reduction is unattainable (for example, physically impossible to reduce emissions by 20%). This trial-and-error method, involving multiple runs to find a feasible solution, significantly increases computational demands due to the manual adjustment and evaluation of different constraints.

### Example 2: Carbon Emissions as an Objective Function

In another example, a company aims to minimize emissions, focusing solely on the maximum reduction of CO2, which leads to high cost premiums. It helps to reduce emissions but doesn't help to bridge the gap with costs. In order to bridge that gap, the user must make manual adjustments and go back to trial and error. Reducing costs involves manually modifying scenarios and adding cost constraints, requiring numerous optimization reruns. This method is arbitrary and computationally demanding, with no assurance of finding cost-effective carbon reduction solutions, highlighting the inefficiency of this approach in balancing sustainability and cost.

### Block Diagram 500

Execution of block diagram 500 provides a set of solutions that optimizes both holding costs and greenhouse emissions in a manner that reduces the amount of computer resources used in traditional heuristically approaches described above. Furthermore, execution of block diagram 500 recommends multiple pareto-efficient solutions in a manner that vastly reduces the use of computer resources and processing time. As discussed above, block diagram 500 executes only three optimizations, thereby reducing the computing resources needed. This is important, since the number of parameters that form a scenario, scales with the number of SKUs and locations. In complex cases, this number can be in the hundreds of thousands.

In some embodiments, the methods and systems disclosed herein allow for the optimization of carbon emissions and optimization of other metrics, simultaneously, in one loop, thereby reducing the both the computational resources and time used in traditional methods.

With reference to block diagram 500, a processor may execute the following steps: at block 502, the processor can receive inputs, such as, but not limited to, costs and carbon emissions data. Costs can include ordering costs, carrying costs and transportation costs. Ordering costs, for example, are costs associated with the number of shipments required and are often delivery-route specific. High ordering costs penalize scenarios where sites are replenished too frequently. Carrying costs, for example, are costs linked to the number of units stored within a network; these are often site-specific. High carrying costs penalize scenarios with excess units stored, especially in sites with elevated per-unit carrying costs. Finally, transportation costs are costs related to the number of units transported between sites; these are transportation-method specific. High transportation costs penalize scenarios employing expensive transportation methods. Carbon emissions data can include holding emissions, fixed transportation emissions and variable transportation emissions. Holding emissions relate to the estimated CO2 output from storing units at a specific site; holding emissions may provide an environmental equivalent to the carrying costs. Fixed emissions are tied to the transportation vehicle, irrespective of the load. Fixed emissions penalize scenarios where sites are replenished too frequently, via polluting transportation methods. Finally, variable transportation emissions are directly associated with the goods being transported; these penalize scenarios for employing vehicles that emit a significant amount of CO2 per unit transported.

Next at block 506. the processor can minimize the total cost, using a first objective function. That is, at block 506, the cost is minimized using a first objective function (as an example, MEIO). This provides a first set of inventory allocations, or, in other words, a first scenario. The associated CO2 is determined from this first scenario, which is a maximum possible value of the CO2 emissions. At block 508, the CO2 emissions is minimized using a second objective function. This provides a second scenario. The associated cost is determined from this second scenario, which is the maximum possible value of the CO2 emissions.

Next, at block 516, the processor performs reconciliation between the two objectives. This can be performed in two steps. At block 504, the processor can first determine a feasible constraint of the CO2 emissions. At block 510, the processor then minimizes the costs under this CO2 emission constraint, thereby reconciling the two competing metrics. In this example, it is the costs that are minimized, while constraining the emissions, during the reconciliation step, since minimization of the costs converges faster (at block 506) than minimizing the emissions (at block 508). The combination of steps at block 504 and block 510 provide a reconciliation of the two objective functions.

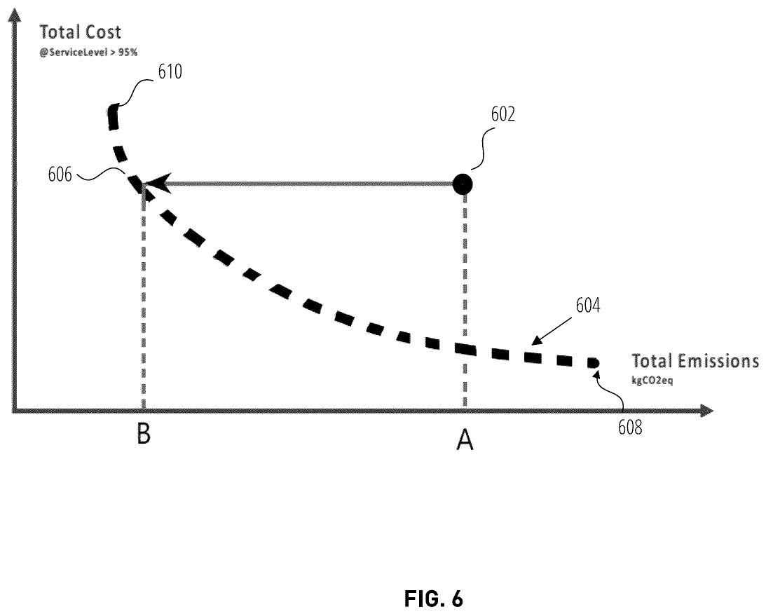

At block 512, a pareto front can be generated based on the three optimizations (at block 506, block 508 and block 510), thereby providing pareto-efficient scenarios (or solutions) at various levels of the two competing metrics. A pareto front is generated, providing a continuous set of solutions of CO2 emissions and cost, in a fraction of the time that has been traditionally required. This is because the optimization of each metric is performed only three times (rather than hundreds, if not thousands, of times using iteration), using their respective objective functions. leading to a reduction in computer processing time. In addition, the two objective functions are reconciled, with the generation of pareto-efficient solutions, thereby avoiding degradation in performance. A pareto-efficient set of solutions, generated by block diagram 500 is shown in FIG. 6.

In an example, the pareto front can be generated from the three optimization points. Two of the three are endpoints, corresponding to minimizing cost and minimizing carbon emissions separately. The third point is generated within this range by minimizing cost while imposing a carbon constraint; this carbon constraint can be set at the midpoint between the emissions of the cost-optimal and carbon-optimal solutions. Once the three points are established, a pareto front can be generated in the form: e(x)=a*x^{b}+c, where x represents costs, and e(x) represents emissions. A power law relationship can be used because the cost of reducing emissions grows exponentially as emissions decrease. In other words, each additional unit of CO2 reduction becomes progressively more expensive. The third point allows capture of the curvature of this trade-off.

With respect to Example 1 above, systems and methods disclosed herein delimit the solution space once (by minimizing costs, minimizing emissions) and then look for cost-efficient carbon reduction opportunities somewhere between those two scenarios. Systems and methods disclosed herein can find one or multiple eco-efficient scenarios based on pre-defined settings (minimum carbon reductions, maximum cost premium, maximum cost per ton of CO2 reduced, etc. . . . ).

With respect to Example 2 above, the solution space is delimited once (by minimizing costs, minimizing emissions) and then looks for cost-efficient carbon reduction opportunities somewhere between those two scenarios. It finds one or multiple eco-efficient scenarios based on pre-defined settings (minimum carbon reductions, maximum cost premium, maximum cost per ton of CO2 reduced, etc. . . . ).

FIG. 6 illustrates application of a set of pareto-efficient solutions in accordance with one embodiment. Here, a scenario in an inventory system is shown at 602, having a total carbon emissions at “A”. There can be many ways on optimizing the emissions. Traditionally, a trial and error approach described above, costing much in computer resources and CPU time, would be used to navigate the two-dimensional space shown in FIG. 2A. However, by using methods and systems disclosed herein, a Pareto Front 604 can be generated by optimizing independently for emissions (to obtain end point 610) and total cost (to obtain end-point 608). The Pareto Front 604 is generated from these two end points 608 and 610, along with at least one reconciliation point (as outlined in FIG. 3). The most eco-efficient solution can now be easily found, without any need for trial and error, for a scenario where the total cost is maintained, which is at 606, resulting in a reduced carbon emission of ‘B’.

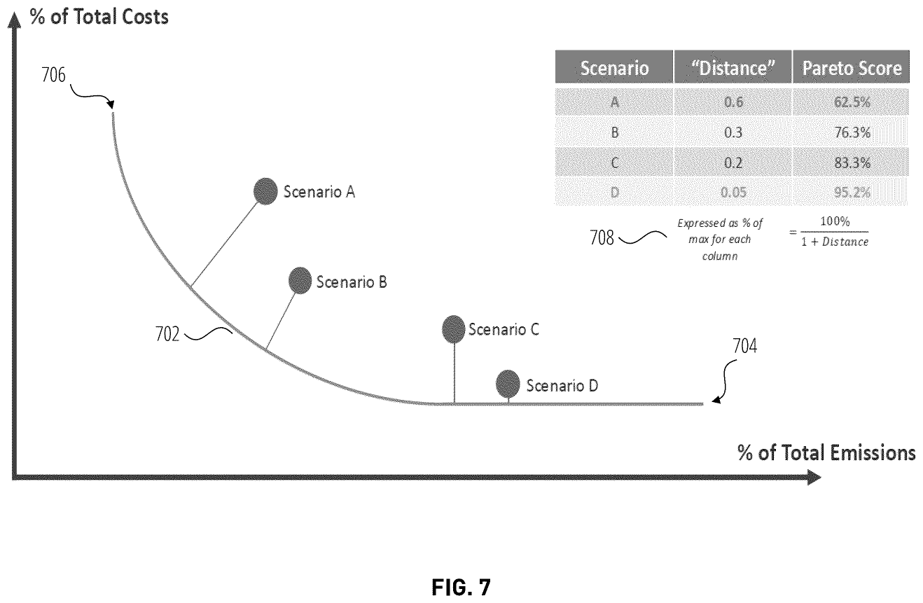

FIG. 7 illustrates application of a set of pareto-efficient solutions in accordance with one embodiment. In FIG. 7, four possible scenarios are presented: A, B, C, D.

Here, there are four possible scenarios, each having a respective % of total costs and % of total emissions. A goal may be to find which of the four scenarios is the closest to the best eco-efficiency. In the traditional approach, a trial-and-error process would be executed for each scenario, in order to find an optimal point for each, thus requiring at least four times the amount of CPU time and resources required for one such determination.

However, the process is greatly simplified by using the methods and systems disclosed herein. The emissions are optimized independently to provide an end point 706, while costs are optimized independently to provide an end point 704, This provides the end points to generate a Pareto Front 702.

The relative eco-efficiency can be evaluated for each scenario, by taking a measure of the distance between each scenario and the Pareto Front. While there are many ways to capture this distance, in the embodiment shown in FIG. 7, a normal (or perpendicular) distance can be calculated between a given scenario and the Pareto Front. The shorter the distance, the closer, or more eco-efficient the scenario, as shown by the “Distance” column in FIG. 7. Alternatively, this distance can be converted to a “Pareto Score” (using the formula 708) such that the higher the Pareto Score, the more eco-efficient the scenario.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing instructions that, when executed by the processor, configure the apparatus to:
receive, by the processor, a first set of data related to a first metric and a second set of data related to a second metric;
optimize, by the processor, a first objective function with respect to the first metric, irrespective of the second metric, resulting in a minimum limit of the first metric;
determine, by the processor, a maximum limit of the second metric from the minimum limit of the first metric, thereby defining a first end point;
optimize, by the processor, a second objective function with respect to the second metric, irrespective of the first metric, resulting in a minimum limit of the second metric;
determine, by the processor, a maximum limit of the first metric from the minimum limit of the second metric, thereby defining a second end point;
select, by the processor, a point between the first end point and the second end point, the point consisting of a value of the first metric and a value of the second metric;
reconcile, by the processor, the first metric and the second metric at the point in between the first end point and the second end point; and
generate, by the processor, a Pareto Front between the first end point and the second end point.

2. The computing apparatus of claim 1, wherein when reconciling the first metric and the second metric, the apparatus is further configured to:
optimize, by the processor, one of the metrics at the point, subject to constraining the other metric.

3. The computing apparatus of claim 2, wherein a metric that optimizes fastest at its respective end point, is selected for optimization at the point between the first end point and the second end point.

4. The computing apparatus of claim 1, wherein the Pareto Front is generated based on a power law.

5. The computing apparatus of claim 1, wherein:
when reconciling the first metric and the second metric, the apparatus is further configured to:
optimize, by the processor, one of the metrics at the point, subject to constraining the other metric, resulting in a reconciled midpoint; and
when generating the Pareto Front, the apparatus is further configured to:
generate, by the processor, a power law based on the first end point, the second end point, and the reconciled midpoint.

6. A non-transitory computer-readable storage medium, the computer-readable storage medium including instructions that when executed by a computer, cause the computer to:
receive, by a processor, a first set of data related to a first metric and a second set of data related to a second metric;
optimize, by the processor, a first objective function with respect to the first metric, irrespective of the second metric, resulting in a minimum limit of the first metric;
determine, by the processor, a maximum limit of the second metric from the minimum limit of the first metric, thereby defining a first end point;
optimize, by the processor, a second objective function with respect to the second metric, irrespective of the first metric, resulting in a minimum limit of the second metric;
determine, by the processor, a maximum limit of the first metric from the minimum limit of the second metric, thereby defining a second end point;
select, by the processor, a point between the first end point and the second end point, the point consisting of a value of the first metric and a value of the second metric;
reconcile, by the processor, the first metric and the second metric at the point in between the first end point and the second end point; and
generate, by the processor, a Pareto Front between the first end point and the second end point.

7. The computer-readable storage medium of claim 6, wherein when reconciling the first metric and the second metric, the computer is further configured to:
optimize, by the processor, one of the metrics at the point, subject to constraining the other metric.

8. The computer-readable storage medium of claim 7, wherein a metric that optimizes fastest at its respective end point, is selected for optimization at the point between the first end point and the second end point.

9. The computer-readable storage medium of claim 6, wherein the Pareto Front is generated based on a power law.

10. The computer-readable storage medium of claim 6, wherein:
when reconciling the first metric and the second metric, the computer is further configured to:
optimize, by the processor, one of the metrics at the point, subject to constraining the other metric, resulting in a reconciled midpoint; and
when generating the Pareto Front, the computer is further configured to:
generate, by the processor, a power law based on the first end point, the second end point, and the reconciled midpoint.

11. A computer-implemented method for reducing computer resources in determining an optimization based on a first metric and a second metric, the method comprising:
receiving, by a processor, a first set of data related to the first metric and a second set of data related to the second metric;
optimizing, by the processor, a first objective function with respect to the first metric, irrespective of the second metric, resulting in a minimum limit of the first metric;
determining, by the processor, a maximum limit of the second metric from the minimum limit of the first metric, thereby defining a first end point;
optimizing, by the processor, a second objective function with respect to the second metric, irrespective of the first metric, resulting in a minimum limit of the second metric;
determining, by the processor, a maximum limit of the first metric from the minimum limit of the second metric, thereby defining a second end point;
selecting, by the processor, a point between the first end point and the second end point, the point consisting of a value of the first metric and a value of the second metric;
reconciling, by the processor, the first metric and the second metric at the point in between the first end point and the second end point; and
generating, by the processor, a Pareto Front between the first end point and the second end point.

12. The computer-implemented method of claim 11, wherein reconciling the first metric and the second metric comprises:
optimizing, by the processor, one of the metrics at the point, subject to constraining the other metric.

13. The computer-implemented method of claim 12, wherein a metric that optimizes fastest at its respective end point, is selected for optimization at the point between the first end point and the second end point.

14. The computer-implemented method of claim 11, wherein the Pareto Front is generated based on a power law.

15. The computer-implemented method of claim 11, wherein:
reconciling the first metric and the second metric comprises:
optimizing, by the processor, one of the metrics at the point, subject to constraining the other metric, resulting in a reconciled midpoint; and
generating the Pareto Front comprises:
generating, by the processor, a power law based on the first end point, the second end point, and the reconciled midpoint.
